(19) United States
(12) Patent Application Publication
(10) Pub. No.: US 2024/0266524 A1
(43) Pub. Date: Aug. 8, 2024

(54) CATHODES FOR LITHIUM ION BATTERIES AND METHOD FOR MANUFACTURING SUCH CATHODES

(71) Applicant: BASF SE, Ludwigshafen am Rhein (DE)

(72) Inventors: Heino SOMMER, Tuebingen (DE); Xiaohan WU, Ludwigshafen (DE); Hubert GASTEIGER, Munich (DE); Louis HARTMANN, Munich (DE)

(21) Appl. No.: 18/565,963

(22) PCT Filed: Jun. 7, 2022
(86) PCT No.: PCT/EP22/65363

§ 371 Date: Nov. 30, 2023

(30) Foreign Application Priority Data
Jun. 16, 2021 (EP) 21179670.1

(51) Int. Cl. H01M 4/505; H01M 4/04; H01M 4/1391; H01M 4/62; H01M 10/0525; H01M 50/437; H01M 50/44

(52) U.S. Cl. CPC H01M 4/505; H01M 4/0404; H01M 4/1391; H01M 4/622; H01M 4/625; H01M 10/0525; H01M 50/437; H01M 50/44

(57) ABSTRACT

Disclosed herein is a cathode containing a mass that includes:
(1) a lithium-containing cathode active material with a molar manganese content in the range of from 50 mol-% to 85 mol-% referring to metals other than lithium contained in the cathode active material,
(2) SiO₂ in particulate form,
(3) carbon in electrically conductive form, and
(4) binder polymer.

The present invention is directed towards a cathode containing a mass comprising
(1) a lithium-containing cathode active material with a molar manganese content in the range of from 50 to 85 mol-% referring to the metals other than lithium contained in said cathode active material,
(2) SiO₂ in particulate form,
(3) carbon in electrically conductive form, and
(4) binder polymer.

In addition, the present invention is directed towards electrochemical cells containing certain cathodes.

Lithiated transition metal oxides are currently used as electrode active materials for lithium-ion batteries. Extensive research and developmental work have been performed in the past years to improve properties like charge density, specific energy, but also other properties like the reduced cycle life and capacity loss that may adversely affect the lifetime or applicability of a lithium-ion battery. Additional effort has been made to improve manufacturing methods.

Many electrode active materials discussed today are of the type of lithiated nickel-cobaltmanganese oxide (“NCM materials”) or lithiated nickel-cobalt-aluminum oxide (“NCA materials”).

In a typical process for making cathode materials for lithium-ion batteries, first a so-called precursor is being formed by co-precipitating the transition metals as carbonates, oxides or preferably as (oxy)hydroxides. The precursor is then mixed with a lithium compound such as, but not limited to LiOH, Li₂O or Li₂CO₃ and calcined (fired) at high temperatures. Lithium compound(s) can be employed as hydrate(s) or in dehydrated form. The calcination—or firing—generally also referred to as thermal treatment or heat treatment of the precursor—is usually carried out at temperatures in the range of from 600 to 1,000° C. In cases hydroxides or carbonates are used as precursors a removal of water or carbon dioxide occurs first and is followed by the lithiation reaction. The thermal treatment is performed in the heating zone of an oven or kiln.

Extensive research has been performed on improvement of various properties of cathode active materials, such as energy density, charge-discharge performance such as capacity fading, and the like. However, many cathode active materials suffer from limited cycle life and voltage fade. This applies particularly to many Mn-rich cathode active materials in which a so-called manganese leaching may be observed. The manganese may then poison the anode. In addition, gassing during cycling is another observation that is attributed to limited cycle life of manganese-rich cathode.

It was therefore an objective of the present invention to provide electrochemical cells with high-high energy density retention rate but a reduced tendency of capacity fade due to manganese leaching.

Accordingly, the cathodes as defined at the outset have been found, hereinafter also referred to as inventive cathodes. Inventive cathodes contain a mass comprising
(1) a lithium-containing cathode active material with a molar manganese content in the range of from 50 to 85 mol-% referring to the metals other than lithium contained in said cathode active material, hereinafter also referred to as cathode active material (1),
(2) SiO₂ in particulate form, hereinafter also referred to as silica (2),
(3) carbon in electrically conductive form, hereinafter also referred to as carbon (3), and
(4) binder polymer, hereinafter also referred to as binder (4). Binder (4) may include a single polymer or a blend of at least two polymers.

Said mass is then usually attached to a current collector, for example a metal foil, preferably an aluminum foil. Said mass may look homogeneous to the naked eye. However, with a magnification of 500 to 1000, different components such cathode active material (1), silica (2), and carbon (3) may be distinguished. Binder (4) serves as glue to attach the mass to the current collector.

Cathode active material (1), silica (2), carbon (3), and binder (4) will be described in more detail below.

In the context of the present invention, such cathode active materials with a molar manganese content in the range of from 50 to 85 mol-% referring to the metals other than lithium in said cathode active materials include so-called high-voltage spinels with a composition LiNi_{0.5}Mn_{1.5}O₄, doped high-voltage spinels, for example with Co, Fe, Ti, Al, or Cu, and in particular so-called lithium rich materials with a layered structure, general formula Li₁₊ₓTM₁₋ₓO₂ wherein x is in the range of from 0.1 to 0.35 and TM includes two or more transition metals, and 50 to 85 mol-% of TM is Mn, preferably 60 to 70 mol-%.

In a preferred embodiment of the resent invention, said cathode active material has the composition Li₁₊ₓTM₁₋ₓO₂ wherein x is in the range of from 0.1 to 0.35, preferably 0.12 to 0.2, and TM is a combination of elements of the general formula (I)

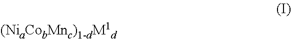

wherein
a is in the range of from 0.20 to 0.40, preferably 0.25 to 0.35,
b being in the range of from zero to 0.20, preferably 0.05 to 0.15,
c being in the range of from 0.50 to 0.85, preferably from 60 to 0.70, and
d being in the range of from zero to 0.02,
M¹ is selected from Al, Ti, Zr, W, Mo, Mg, and Nb, and combinations of at least two of the foregoing, and

$$a + b + c = 1 .$$

Cathode active material (1) may be coated or non-coated.

Coated cathode active materials as discussed in the context with the present invention refer to at least 50% of the particles of a batch of particulate cathode active material being coated, and to 0.5 to 2.5% of the surface of each particle being coated, for example 0.75 to 1.25%. The coating may comprise a non-lithiated oxide or a lithiated oxide or a combination of non-lithiated an lithiated oxides. Examples of non-lithiated oxides are Al₂O₃, B₂O₃, TiO₂, Sb₂O₃, ZrO₂, WO₃, Nb₂O₅, and combinations of at least two of the foregoing. Examples of lithiated oxides are Li₂TiO₃, Li₄TiO₄, Li₂ZrO₃, LiNbO₃, LiSbO₃, Li₂WO₄, LiBO₂, Li₃BO₃, Li₂B₄O₇, and combinations of at least two of the foregoing.

In one embodiment of the present invention, cathode active materials (1) have an average particle diameter D50 in the range of from 2 to 20 μm, preferably from 5 to 16 μm. The average particle diameter may be determined, e.g., by light scattering or LASER diffraction or electroacoustic spectroscopy. The particles are usually composed of agglomerates from primary particles, and the above particle diameter refers to the secondary particle diameter.

In one embodiment of the present invention, cathode active materials (1) have a specific surface (BET) in the range of from 0.7 to 6.0 m²/g, determined according to DIN-ISO 9277:2003-05, preferred are 1.7 to 3.8 m²/g or even from 3.0 up to 5.5 m²/g.

Some metals are ubiquitous such as sodium, calcium or zinc and traces of them virtually present everywhere, but such traces will not be taken into account in the description of the present invention. Traces in this context will mean amounts of 0.05 mol-% or less, referring to the total metal content TM.

M¹ may be dispersed homogeneously or unevenly in particles of cathode active material (1). Preferably, M¹ is distributed unevenly in particles of cathode active material (1), even more preferably as a gradient, with the concentration of M¹ in the outer shell being higher than in the center of the particles.

In one embodiment of the present invention, cathode active material (1) is comprised of spherical particles, that are particles have a spherical shape. Spherical particles shall include not just those which are exactly spherical but also those particles in which the maximum and minimum diameter of at least 90% (number average) of a representative sample differ by not more than 10%.

In one embodiment of the present invention, cathode active material (1) is comprised of secondary particles that are agglomerates of primary particles. Preferably, inventive cathode active material is comprised of spherical secondary particles that are agglomerates of primary particles. Even more preferably, inventive cathode active material is comprised of spherical secondary particles that are agglomerates of platelet primary particles.

In one embodiment of the present invention, said primary particles of cathode active material (1) have an average diameter in the range from 1 to 2000 nm, preferably from 10 to 1000 nm, particularly preferably from 50 to 500 nm. The average primary particle diameter can, for example, be determined by SEM or TEM. SEM is an abbreviation of scanning electron microscopy, TEM is an abbreviation of transmission electron microscopy.

In one embodiment of the present invention, cathode active material (1) has a monomodal particle diameter distribution. In an alternative embodiment, cathode active material (1) has a bimodal particle diameter distribution, for example with a maximum in the range of from 3 to 6 μm and another maximum in the range of from 9 to 12 μm.

In one embodiment of the present invention, the pressed density of cathode active material (1) is in the range of from 2.75 to 3.1 g/cm³, determined at a pressure of 250 MPa, preferred are 2.85 to 3.10 g/cm³.

Inventive cathodes further comprise silica (2), preferably with an average particle diameter (d50) in the range of from 5 to 100 nm, preferably from 5 to 20 nm. The average particle diameter (d50) refers to the average particle diameter of the primary particles. Said primary particles may agglomerate to form agglomerates, however, deagglomeration may be achieved by stirring, e.g., during cathode manufacture. Said agglomerates may have an average diameter (D50) in the range of from 100 nm to 100 μm, preferably from 100 nm to 1 μm. The particle diameter determination may be performed by particle size analysis, for example with a Malvern Panalytical.

In one embodiment of the present invention, silica (2) is employed as sand. In a preferred embodiment of the present invention, silica (2) is selected from spray-dried silica and fumed silica. Spray-dried silica may be manufactured by acidification of an aqueous solution of water glass, followed by spray-drying. Fumed silica may be made from flame pyrolysis of SiCl₄ or from quartz silica vaporized in an electric arc.

Silica (2) is in particular form. Preferably, the particles are spheroidal or spherical.

Silica (2) may have an acidic surface, determined by mixing silica with water and determining the pH value. The pH value of a 10% by weight solution may be in the range of from 3.5 to 6.5, determined at 23° C.

Inventive cathodes further comprise carbon (3). Carbon (3) can be selected from soot, active carbon, carbon nanotubes, graphene, and graphite, and from combinations of at least two of the foregoing.

Suitable binders (4) are preferably selected from organic (co)polymers. Suitable (co)polymers, i.e. homopolymers or copolymers, can be selected, for example, from (co)polymers obtainable by anionic, catalytic or free-radical (co)polymerization, especially from polyethylene, polyacrylonitrile, polybutadiene, polystyrene, and copolymers of at least two comonomers selected from ethylene, propylene, styrene, (meth)acrylonitrile and 1,3-butadiene. Polypropylene is also suitable. Polyisoprene and polyacrylates are additionally suitable. Particular preference is given to polyacrylonitrile.

In the context of the present invention, polyacrylonitrile is understood to mean not only polyacrylonitrile homopolymers but also copolymers of acrylonitrile with 1,3-butadiene or styrene. Preference is given to polyacrylonitrile homopolymers.

In the context of the present invention, polyethylene is not only understood to mean homopolyethylene, but also copolymers of ethylene which comprise at least 50 mol-% of copolymerized ethylene and up to 50 mol-% of at least one further comonomer, for example α-olefins such as propylene, butylene (1-butene), 1-hexene, 1-octene, 1-decene, 1-dodecene, 1-pentene, and also isobutene, vinylaromatics, for example styrene, and also (meth)acrylic acid, vinyl acetate, vinyl propionate, C₁-C₁₀-alkyl esters of (meth)acrylic acid, especially methyl acrylate, methyl methacrylate, ethyl acrylate, ethyl methacrylate, n-butyl acrylate, 2-ethylhexyl acrylate, n-butyl methacrylate, 2-ethylhexyl methacrylate, and also maleic acid, maleic anhydride and itaconic anhydride. Polyethylene may be HDPE or LDPE.

In the context of the present invention, polypropylene is not only understood to mean homopolypropylene, but also copolymers of propylene which comprise at least 50 mol-% of copolymerized propylene and up to 50 mol-% of at least one further comonomer, for example ethylene and α-olefins such as butylene, 1-hexene, 1-octene, 1-decene, 1-dodecene and 1-pentene. Polypropylene is preferably isotactic or essentially isotactic polypropylene.

In the context of the present invention, polystyrene is not only understood to mean homopolymers of styrene, but also copolymers with acrylonitrile, 1,3-butadiene, (meth)acrylic acid, C₁-C₁₀-alkyl esters of (meth)acrylic acid, divinylbenzene, especially 1,3-divinylbenzene, 1,2-diphenylethylene and α-methylstyrene.

Another preferred binder (4) is polybutadiene.

Other suitable binders (4) are selected from polyethylene oxide (PEO), cellulose, carboxymethylcellulose, polyimides and polyvinyl alcohol.

In one embodiment of the present invention, binder (4) is selected from those (co)polymers which have an average molecular weight M_{w} in the range from 50,000 to 1,000,000 g/mol, preferably to 500,000 g/mol.

Binder (4) may be selected from cross-linked or non-cross-linked (co)polymers.

In a particularly preferred embodiment of the present invention, binder (4) is selected from halogenated (co)polymers, especially from fluorinated (co)polymers. Halogenated or fluorinated (co)polymers are understood to mean those (co)polymers which comprise at least one (co)polymerized (co)monomer which has at least one halogen atom or at least one fluorine atom per molecule, more preferably at least two halogen atoms or at least two fluorine atoms per molecule. Examples are polyvinyl chloride, polyvinylidene chloride, polytetrafluoroethylene, polyvinylidene fluoride (PVdF), tetrafluoroethylene-hexafluoropropylene copolymers, vinylidene fluoride-hexafluoropropylene copolymers (PVdF-HFP), vinylidene fluoride-tetrafluoroethylene copolymers, perfluoroalkyl vinyl ether copolymers, ethylene-tetrafluoroethylene copolymers, vinylidene fluoride-chlorotrifluoroethylene copolymers and ethylene-chlorofluoroethylene copolymers.

Suitable binders (4) are especially polyvinyl alcohol and halogenated (co)polymers, for example polyvinyl chloride or polyvinylidene chloride, especially fluorinated (co)polymers such as polyvinyl fluoride and especially polyvinylidene fluoride and polytetrafluoroethylene.

In one embodiment of the present invention, inventive cathodes comprise
(1) in the range of from 80 to 95% by weight cathode active material, preferably from 90 to 95% by weight,
(2) in the range of from 1 to 10% by weight SiO₂ in particulate form, preferably from 1 to 5% by weight,
(3) in the range of from 1 to 10% by weight carbon in electrically conductive form, preferably from 1 to 3% by weight,
(4) in the range of from 1 to 5% by weight of a binder polymer, preferably from 2 to 4% by weight,
percentages referring to the sum of (1), (2), (3) and (4). The weight of the current collector is thus neglected.

Electrochemical cells containing inventive cathodes display excellent electrochemical properties, especially with respect to Mn leaching.

A further aspect of the present invention is an electrochemical cell containing
(A) an inventive cathode comprising inventive electrode active material, carbon, and binder,
(B) a anode,
(C) a separator, and
(D) electrolyte.

Embodiments of inventive cathodes (A) have been described above in detail.

Said anode (B) may contain at least one anode active material, such as carbon (graphite), TiO₂, lithium titanium oxide, silicon or tin or silicon alloys. Said anode may additionally contain a current collector, for example a metal foil such as a copper foil.

In one embodiment of the present invention, cells according to the invention comprise one or more separators (C) by means of which the electrodes are mechanically separated. Suitable separators (C) are polymer films, in particular porous polymer films that are unreactive toward metallic lithium. Particularly suitable materials for separators are polyolefins, in particular film-forming porous polyethylene and film-forming porous polypropylene.

Separators (C) composed of polyolefin, in particular polyethylene or polypropylene, can have a porosity in the range from 35 to 45%. Suitable pore diameters are, for example, in the range from 30 to 500 nm.

In another embodiment of the present invention, separators (C) are selected from among PET nonwovens filled with inorganic particles. Such separators can have porosities in the range from 40 to 55%. Suitable pore diameters are, for example, in the range from 80 to 750 nm.

Preferred separators (C) are selected from those comprising glass fibers.

Electrolyte (D) may comprise at least one non-aqueous solvent, at least one electrolyte salt and, optionally, additives.

Non-aqueous solvents for electrolytes can be liquid or solid at room temperature and is preferably selected from among polymers, cyclic or acyclic ethers, cyclic and acyclic acetals and cyclic or acyclic organic carbonates.

Examples of suitable polymers are, in particular, polyalkylene glycols, preferably poly-C₁-C₄-alkylene glycols and in particular polyethylene glycols. Polyethylene glycols can here comprise up to 20 mol-% of one or more C₁-C₄-alkylene glycols. Polyalkylene glycols are preferably polyalkylene glycols having two methyl or ethyl end caps.

The molecular weight M_{w} of suitable polyalkylene glycols and in particular suitable polyethylene glycols can be at least 400 g/mol.

The molecular weight M_{w} of suitable polyalkylene glycols and in particular suitable polyethylene glycols can be up to 5 000 000 g/mol, preferably up to 2 000 000 g/mol.

Examples of suitable acyclic ethers are, for example, diisopropyl ether, di-n-butyl ether, 1,2-dimethoxyethane, 1,2-diethoxyethane, with preference being given to 1,2-dimethoxyethane.

Examples of suitable cyclic ethers are tetrahydrofuran and 1,4-dioxane.

Examples of suitable acyclic acetals are, for example, dimethoxymethane, diethoxymethane, 1,1-dimethoxyethane and 1,1-diethoxyethane.

Examples of suitable cyclic acetals are 1,3-dioxane and in particular 1,3-dioxolane.

Examples of suitable acyclic organic carbonates are dimethyl carbonate, ethyl methyl carbonate and diethyl carbonate.

Examples of suitable cyclic organic carbonates are compounds according to the general formulae (II) and (III)

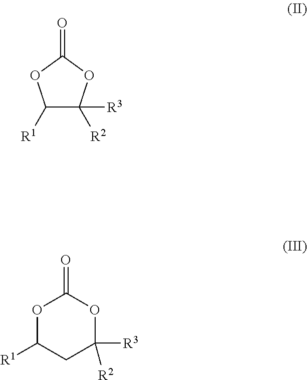

where R¹, R² and R³ can be identical or different and are selected from among hydrogen and C₁-C₄-alkyl, for example methyl, ethyl, n-propyl, isopropyl, n-butyl, isobutyl, sec-butyl and tert-butyl, with R² and R³ preferably not both being tert-butyl.

In particularly preferred embodiments, R¹ is methyl and R² and R³ are each hydrogen, or R¹, R² and R³ are each hydrogen. In an alternative embodiment, R¹ is F and R² and R³ are each hydrogen.

Another preferred cyclic organic carbonate is vinylene carbonate, formula (IV).

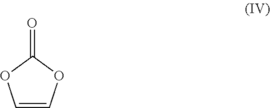

The solvent or solvents is/are preferably used in the water-free state, i.e. with a water content in the range from 1 ppm to 0.1% by weight, which can be determined, for example, by Karl-Fischer titration.

Electrolyte further comprises at least one electrolyte salt. Suitable electrolyte salts are, in particular, lithium salts. Examples of suitable lithium salts are LiPF₆, LiBF₄, LiClO₄, LiAsF₆, LiCF₃SO₃, LiC(CₙF₂ₙ₊₁SO₂)₃, lithium imides such as LIN(CₙF₂ₙ₊₁SO₂)₂, where n is an integer in the range from 1 to 20, LiN(SO₂F)₂, Li₂SiF₆, LiSbF₆, LiAlCl₄ and salts of the general formula (CₙF₂ₙ₊₁SO₂)ₜYLi, where m is defined as follows:
t=1, when Y is selected from among oxygen and sulfur,
t=2, when Y is selected from among nitrogen and phosphorus, and
t=3, when Y is selected from among carbon and silicon.

Preferred electrolyte salts are selected from among LiC(CF₃SO₂)₃, LIN(CF₃SO₂)₂, LiPF₆, LiBF₄, LiClO₄, with particular preference being given to LiPF₆ and LiN(CF₃SO₂)₂.

Batteries according to the invention further comprise a housing which can have any shape, for example cuboidal or the shape of a cylindrical disk or a cylindrical can. In one variant, a metal foil configured as a pouch is used as housing.

Batteries according to the invention display a good discharge behavior, a very good discharge and cycling behavior, and a strongly reduced tendency of manganese leaching.

Batteries according to the invention can comprise two or more electrochemical cells that combined with one another, for example can be connected in series or connected in parallel. Connection in series is preferred. In batteries according to the present invention, at least one of the electrochemical cells contains at least one cathode according to the invention. Preferably, in electrochemical cells according to the present invention, the majority of the electrochemical cells contains a cathode according to the present invention. Even more preferably, in batteries according to the present invention all the electrochemical cells contain cathodes according to the present invention.

The present invention further provides for the use of batteries according to the invention in appliances, in particular in mobile appliances. Examples of mobile appliances are vehicles, for example automobiles, bicycles, aircrafts or water vehicles such as boats or ships. Other examples of mobile appliances are those which move manually, for example computers, especially laptops, telephones or electric hand tools, for example in the building sector, especially drills, battery-powered screwdrivers or battery-powered staplers.

A further aspect of the present invention is related to a process for manufacturing inventive cathodes, hereinafter also referred to as inventive process or inventive manufacturing process.

The inventive process comprises the following steps:
(a) combining
   (1) a lithium-containing cathode active material with a molar manganese content in the range of from 50 to 85 mol-% referring to the metals other than lithium contained in said cathode active material,
   (2) SiO₂ in particulate form,
   (3) carbon in electrically conductive form, and
   (4) binder polymer
      in the presence of an organic solvent or of water,
(b) applying the mixture from step (a) to a current collector,
(c) removing the water or organic solvent from step (a).

Cathode active material (1), silica (2), carbon (3), and binder (4) have been described in more detail above.

Steps (a) may hereinafter also briefly be referred to as (a). Step (b) may hereinafter also briefly be referred to as (b). Step (c) may hereinafter also briefly be referred to as (c).

In step (a), cathode active material (1), silica (2), carbon (3), and binder (4) are combined in one step or in two or more sub-steps. Preferred is one step. Combining cathode active material (1), silica (2), carbon (3), and binder (4) may be supported by mixing operations, for example by stirring. Fast stirring is preferred, for example with 1000 to 15,000 revolutions (“rpm”) per minute.

Step (a) is performed in the presence of water or of an organic solvent or of a combination of water and an organic solvent or of a combination of at least two organic solvents. Of organic solvents, non-chlorinated solvents are preferred. Of organic solvents, aprotic solvents are preferred. More preferred examples of organic solvents are acetone, tetrahydrofuran (THF), Nethylpyrrolidone (NEP), N-methylpyrrolidone (NMP) and N,N-dimethylformamide (DMF).

Step (a) may be performed at a temperature in the range of from 5 to 60° C., preferred are 15 to 40° ° C., and even more preferred is ambient temperature.

The mixture resulting from step (a) may have the appearance of a slurry or of a paste, and it may have a solids content in the range of from 5 to 80% or of from 80.5% up to 95%.

The mixture resulting from step (a) is preferably lump-free, so no lumps can be detected with the naked eye.

In one embodiment of the present invention, the mixture resulting from step (a) has a dynamic viscosity at 23° C. in the range of from 200 to 5,000 mPa's, preferably from 100 to 800 mPa·s, determined at a shear rate of 10 Hz. The dynamic viscosity may be determined, e.g., by rotational viscometry, for example by means of a Haake viscosimeter.

In step (b), the mixture resulting from step (a) is then applied to a current collector. Said application may be performed by means of a slit nozzle or by spraying or with a doctor blade, depending on the viscosity of the mixture. Extrusions are possible as well.

The mixture resulting from step (a) may have a thickness in the range of from 30 to 500 μm, preferably 50 to 200 μm, determined after step (c) in order to eliminate the influence of the solvent.

The mixture resulting from step (a) may be applied to one side or preferably to both sides of the current collector, in one or more cycles of steps (b) and (c).

Step (c) includes removing the water or organic solvent from step (a). Said removal may be performed by freeze drying, vacuum drying heating, for example to temperatures from 25 to 150° C., preferably 100 to 130° C., or combinations of heating and vacuum drying or freeze and vacuum drying.

In case vacuum drying is performed, a pressure in the range of from 10 to 100 mbar (abs) is preferred. It is furthermore preferred to displace the vapors from solvent(s) and to feed some inert gas, for example N₂, at the working conditions, for example at 100 mbar.

The duration of step (c) may be in the range of from one minute to 24 hours, preferably 10 minutes to 24 hours.

Step (c) may be carried out, e.g., in a drying tunnel. Residence time in a drying tunnel may be in the range of from 5 to 30 minutes, preferably 10 to 20 minutes.

A blank is obtained from step (c) that may serve as cathode directly, or that may be customized (“finished”), for example by cutting into the desired shape. In a preferred embodiment, the blank is first compacted, step (d), thermally treated, step (e), and then finished. A preferred way how to perform step (d) is in a calendar or in a press.

Preferred conditions for performing step (d) in a calendar are a line pressure of the rollers of said calendar in the range of from 100 to 500 N/mm, preferably 110 to 150 N/mm. Suitable processing speeds are from 0.1 to 1 m/min.

Preferred conditions for performing step (d) in a press are a pressure in the range of from 100 to 1000 MPa, preferably 100 to 500 MPa. Suitable residence times are from 5 to 10 minutes.

Suitable processing temperatures for step (d) are in the range of from 15 to 95° C., preferred are 25 to 35° C.

The thermal treatment step (e) includes heating of the compacted blank from step (d) to a temperature of up to 35 to 5° C. below the melting—or softening—point of binder (4), see, e.g., US 2015/0280206, or even higher, for example above the melting or softening point of binder (4), for example up to 50° C. higher. A decomposition of binder (4), however should be avoided.

Examples of finishing steps are stamping or cutting or punching in order to obtain the desired geometry.

The present invention is further illustrated by the following working examples.

Average particle diameters (D50) were determined by dynamic light scattering (“DLS”). Percentages are % by weight unless specifically noted otherwise.

The surface acidity was determined after stirring 500 mg of silica (2.1) in 5 ml distilled water for 15 min.

Percentages and ppm refer to weight percent and ppm by weight, respectively unless specifically noted otherwise.

### Starting Materials:

Cathode active material (1.1) (“CAM (1.1)”: Li_{1.14}(Ni_{0.26}Co_{0.14}Mn_{0.60})_{0.86}O₂

CAM (1.1) was manufactured as follows:

A precursor was made by precipitating a mixed Ni—Co—Mn carbonate from a solution containing nickel sulfate/cobalt sulfate/manganese sulfate in a molar ratio of 26:14:60 followed by drying under air at 200° C. Precipitating agent was aqueous sodium carbonate solution in aqueous ammonia solution. Average particle diameter (D50): 10.2 μm.

In a roller hearth kiln, a saggar filled with an intimate mixture of precursor and Li₂CO₃ so the molar ratio of lithium to the sum of transition metals is 1.42:1. Said mixture is heated to 800° C. in a forced stream of air. When a temperature of 800° C. is reached, heating is continued at 800° C. over a period of time of 4 hours. The formation of metal oxide is observed, formula 0.33Li₂MnO₃·0.67Li(Ni_{0.4}Co_{0.2}Mn_{0.4})O₂. This corresponds to a formula of Li_{1.14}TM_{0.86}O₂.
Silica (2.1): (details: fumed silica, particle diameter 5 to 15 nm, acidity: pH value 6.5 at 23° C., purchased from Sigma-Aldrich)
Carbon (3.1): carbon black, commercially available as SuperC65, Imerys, Switzerland
Binder (4.1): polyvinylidene fluoride (PVDF, Solef5130, Solvay, Belgium)

All operations of step (a) were performed in a glove box, (O₂ and H₂O below 0.1 ppm).

### I. Cathode Manufacture

### I.1 Manufacture of an Inventive Cathode, (A.1):

CAM (1.1), silica (2.1), carbon (3.1), and binder (4.1) were mixed in a weight ratio of 87.5:5.0:4.0:3.5.

Step (a.1): A dissolver (Dispermat LC30, VMA-Getzmann, Germany) was charged with carbon (3.1) and binder (4.1), at 5000 rpm for 5 minutes. Then, silica (2.1) in NMP, solids content 50%, was added in three portions, and the resultant ink-like slurry was mixed at 10,000 rpm for 5 minutes after each NMP addition. Then, CAM (1.1) was added, and the resultant slurry was mixed for another 5 minutes, 10,000 rpm.

Step (b.1): The mixture from step (a.1) was then coated onto an aluminum foil (thickness 18 μm, MTI Corporation, USA) using a four-edge blade (RK PrintCoat Instruments, UK). A coated aluminum foil was obtained.

Step (c.1): The coated aluminum foil was dried inside the glovebox at ambient temperature over 15 hours to evaporate the NMP.

Steps (d.1) and (e.1) were performed after customizing:

### Finishing:

Disk-shaped crude cathodes with a diameter of 14 mm were punched out.

Step (d.1) and (e.1): The disk shaped crude cathodes were compressed with a hydraulic press at 2.5 tons (corresponding to ˜160 MPa) and dried for 15 hours at 120° ° C. under dynamic vacuum in a glass oven (drying oven 585, Büchi, Switzerland). The CAM loading was 8.5 mg CAM(1.1)/cm², corresponding to 2.1 mA·h/cm² (based on a nominal specific capacity of 250 mA·h/g CAM (1.1)). Inventive cathode (A.1) was obtained.

### I.2 Manufacture of a Comparative Cathode, C-(A.2)

CAM (1.1), silica (2.1), carbon (3.1), and binder (4.1) were mixed in a weight ratio of 92.5:zero:4.0:3.5.

Step C-(a.2): A dissolver (Dispermat LC30, VMA-Getzmann, Germany) was charged with carbon (3.1) and binder (4.1), at 5000 rpm for 5 minutes. Then, silica (2.1) in NMP, solids content 50%, was added in three portions, and the resultant ink-like slurry was mixed at 10,000 rpm for 5 minutes after each NMP addition. Then, CAM (1.1) was added, and the resultant slurry was mixed for another 5 minutes, 10,000 rpm.

Step (b.2): The mixture from step C-(a.2) was then coated onto an aluminum foil (thickness 18 μm, MTI Corporation, USA) using a four-edge blade (RK PrintCoat Instruments, UK). A coated aluminum foil was obtained.

Step (c.2): The coated aluminum foil was dried inside the glovebox at ambient temperature over 15 hours to evaporate the NMP.

Steps (d.2) and (e.2) were performed after customizing:

### Finishing:

Disk-shaped crude cathodes with a diameter of 14 mm were punched out.

Step (d.2) and (e.2): The disk shaped crude cathodes were compressed with a hydraulic press at 2.5 tons (corresponding to ˜160 MPa) and dried for 15 hours at 120° C. under dynamic vacuum in a glass oven (drying oven 585, Büchi, Switzerland). The CAM loading was 8.5 mg

CAM(1.1)/cm², corresponding to 2.1 mAh/cm² (based on a nominal specific capacity of 250 mAh/g CAM (1.1)). Comparative cathode C-(A.2) was obtained

### II. Manufacture of Electrochemical Cells and Testing

### II. 1 Manufacture of Coin Cells

Anode (B.1): graphite on copper foil

### II.2 Testing

Galvanostatic cycling was carried out in 2032-type coin-cells (Hohsen Corp., Japan) at 25° C. in a temperature-controlled oven (Binder, Germany) and using a battery cycler (Series 4000, Maccor, USA). For full-cell experiments, a graphite anode with a diameter of 15 mm and a cathode with a diameter of 14 mm were assembled with either two Celgard® polypropylene separators (CG, C2500, Celgard, USA), (C.1), or two glass fiber separators (GF, glass microfiber, GF/A, VWR, Germany), (C.2), containing in each case 80 ul of 1 M LiPF₆ in fluoroethylenecarbonate/diethyl carbonate (2:8 g:g) electrolyte. After assembly, all cells were rested for 2 h prior to charge/discharge cycling (in order to fully wet the separator) and C-rates are referenced to a nominal capacity of 250 mAh/g. The full-cells with LRM-NCM cathodes were activated in the first cycle at a C-rate of C/15 to 4.7 V with a constant-current procedure (CC) and then discharged at C/15 to 2.0 V (CC). In the subsequent 3 cycles, the upper cut-off cell voltage was reduced to 4.6 V and the C-rate amounts to C/10 during charge and discharge. This was followed by fast cycles, for which the cell is charged/discharged for 3 cycles each at C/2 (CCCV)/3C (CC), whereby all constant-voltage (CV) steps were terminated after 1 h or when the current drops below C/100. This is followed by 33 cycles at a charge rate of C/2 (CCCV) and a discharge rate of 1C (CC), whereby the CV step is defined as above. This sequence of 3 C/10, 3 3C and 33 1C discharge cycles was repeated for 120 cycles in total.

TABLE 1
Electrochemical Cell testing

| | 1^{st} charge | 1^{st} Discharge | 30^{th} Discharge | 50^{th} Discharge | 100^{th} Discharge | Capacity |
|---|---|---|---|---|---|---|
| | capacity | capacity | capacity | capacity | capacity | retention |
| CAM | [mA · h/g] | [mA · h/g] | [mA · h/g] | [mA · h/g] | [mA · h/g] | (Cyc. 10-100) [%] |
| A.1 | 309.1 | 271.4 | 210.0 | 206.0 | 197 | 91.2 |
| C-(A.2) | 301.3 | 274.5 | 186.0 | 177.0 | 147 | 71.3 |

1. A cathode containing a mass comprising:
(1) a lithium-containing cathode active material with a molar manganese content in a range of from 50 mol-% to 85 mol-% referring to metals other than lithium contained in said cathode active material,
(2) SiO₂ in particulate form with an average particle diameter (D50) in a range of from 5 nm to 100 nm,
(3) carbon in electrically conductive form, and
(4) binder polymer,
wherein said mass is coated on a current collector.

2. (canceled)

3. The cathode according to claim 1 comprising:
(1) in a range of from 80% to 95% by weight cathode active material,
(2) in a range of from 1% to 10% by weight SiO₂ in particulate form,
(3) in a range of from 1% to 10% by weight carbon in electrically conductive form,
(4) in a range of from 1% to 5% by weight of binder polymer,
percentages referring to a sum of (1), (2), (3), and (4).

4. The cathode according to claim 1, wherein said SiO₂ is selected from the group consisting of spray-dried silica and fumed silica.

5. The cathode according to claim 1, wherein the cathode active material has a composition LiNi_{0.5}Mn_{1.5}O₄.

6. Cathode The cathode according to claim 1, wherein the cathode active material has a composition Li₁₊ₓTM₁₋ₓO₂, wherein x is in a range of from 0.1 to 0.35, and TM is a combination of elements of a general formula (I) 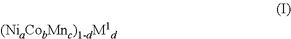
wherein
a is in a range of from 0.20 to 0.40,
b being in a range of from zero to 0.20,
c being in a range of from 0.60 to 0.70, and
d being in a range of from zero to 0.02,
M¹ is selected from the group consisting of Al, Ti, Zr, W, Mo, Mg, and Nb, and
a+b+c=1.

7. The cathode according to claim 6, wherein a>b.

8. An electrochemical cell containing:
(A) a cathode according to claim 1.

9. The electrochemical cell according to claim 8 further comprising:
(B) a separator comprising glass fibers.

10. A process for manufacturing a cathode according to claim 1, wherein said process comprises the following steps:
(a) combining:
(1) a lithium-containing cathode active material with a molar manganese content in a range of from 50 mol-% to 85 mol-% referring to metals other than lithium contained in the cathode active material,
(2) SiO₂ in particulate form with an average particle diameter (D50) in a range of from 5 nm to 100 nm,
(3) carbon in electrically conductive form, and
(4) binder polymer
in the presence of an organic solvent or of water,
(b) applying the mixture from step (a) to a current collector, and
(c) removing the water or the organic solvent from step (a).
